(19) United States
(12) Patent Application Publication
(10) Pub. No.: US 2026/0017638 A1
(43) Pub. Date: Jan. 15, 2026

(54) MULTI-USER ACCOUNT SERVICE ACCESS SYSTEM

(71) Applicant: Apple Inc., Cupertino, CA (US)

(72) Inventors: Glen W. STEELE, San Jose, CA (US); George R. DICKER, Sunnyvale, CA (US); Matthew C. BYINGTON, Sunnyvale, CA (US); Richard William Thomas HEARD, San Francisco, CA (US)

(21) Appl. No.: 18/773,474

(22) Filed: Jul. 15, 2024

Related U.S. Application Data
(63) Continuation of application No. 15/994,992, filed on May 31, 2018, now abandoned.
(60) Provisional application No. 62/514,748, filed on Jun. 2, 2017.

(51) Int. Cl. G06Q 20/32; G06Q 20/40

(52) U.S. Cl. CPC G06Q 20/3255; G06Q 20/4014; G06Q 2220/00

(57) ABSTRACT

A device implementing a peer transaction system may include at least one processor configured to receive, within a messaging application, a request to send a transaction amount from a first user to a second user. The at least one processor may be further configured to transmit, to a mobile transaction system, a request to transfer the transaction amount from a first debit account of the first user to a second debit account of the second user. The at least one processor may be further configured to receive, from the mobile transaction system, a confirmation that the transaction amount has been transferred from the first user to the second user. The at least one processor may be further configured to transmit, via the messaging application, a message to the second user that indicates that the transaction amount has been sent from the first user to the second user.

### TECHNICAL FIELD

The present description relates generally to an electronic transaction system, including a peer transaction system.

### BACKGROUND

In a mobile payment system, devices, such as phones, smart watches, etc., may be used to conduct payment transactions with wireless transaction terminals. For example, one or more applets that correspond to one or more card accounts (e.g., credit card accounts, debit card accounts, loyalty card accounts, etc.), may be provisioned on a secure element of an electronic device and used to conduct wireless transactions with wireless transaction terminals.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a peer payment system may be implemented in accordance with one or more implementations.

FIG. 2 illustrates an example electronic device that may be used in a peer payment system in accordance with one or more implementations.

FIG. 3 illustrates an example electronic device including an example secure element that may be used in a peer payment system in accordance with one or more implementations.

FIG. 4 illustrates an example communication flow in a peer payment system in accordance with one or more implementations.

FIG. 5 illustrates a flow diagram of an example process of an electronic device sending a payment in accordance with one or more implementations.

FIG. 6 illustrates a flow diagram of an example process of a mobile payment system server facilitating a peer payment in accordance with one or more implementations.

FIG. 7 illustrates a flow diagram of an example process of a mobile payment system server providing transaction records from a debit provider server to a transaction storage/distribution server in accordance with one or more implementations.

FIG. 8 illustrates a flow diagram of an example process of a transaction storage/distribution server in accordance with one or more implementations.

FIG. 9 illustrates a flow diagram of an example process of funding a peer payment in accordance with one or more implementations.

FIG. 10 conceptually illustrates an electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In wireless payment systems, applets that correspond to a user's card accounts may be provisioned on a secure element of the user's device(s). The applets on the secure element may be used to conduct payment transactions with wireless transaction terminals, e.g. in lieu of using the physical cards that correspond to the card accounts. However, such wireless payment systems may not provide functionality that allows users to send payments to other users. Such wireless payment systems also may not provide a convenient mechanism for a user to receive funds, e.g., from another user.

In the subject peer payment system, when a user registers for the peer payment system a debit account (or cash balance account) is created for the user, e.g., with a debit account provider that is associated with the peer payment system. The user may add funds to the debit account, which may be used to send payments to other users of the peer payment system and/or to merchants offering goods and/or services. For example, a messaging application may implement functionality that allows a user to send payments to other users, e.g., in conjunction with messaging. When the user sends a payment to another user, the funds are deducted from the user's debit account and the funds are deposited directly into the other user's debit account, e.g., with the same debit account provider or a different debit account provider. In addition, an applet corresponding to the debit account may be provisioned on the secure element(s) of the user's device(s), such that the user may use the funds added to their debit account to conduct payment transactions, e.g., with wireless transaction terminals and/or through in-app/web-based transactions.

The subject system also aggregates the user's transaction records with respect to the debit account and stores the transaction records on a server in an encrypted container, the contents of which can only be decrypted by the user's devices, thereby ensuring the user's privacy. The server may provide for synchronization of the encrypted container across all of the user's devices such that the user can access their transaction records on any of their devices, irrespective of the device on which the transactions were performed.

The subject system may allow users to fund payments using funds from multiple different sources, such as from their debit account provided by the subject system and from one or more external accounts (such as bank account or a credit card account). The subject system allows users to specify the amount of the payment that should be funded from their debit account (if any) and the amount of the payment that should be funded from another source, such as an external account. In this manner, the subject system provides users with discrete control over how a payment is funded. Furthermore, when a payment is funded in whole or in part from an external account, the funds can be withdrawn from the external account and sent directly to the debit account of the recipient, e.g., without being deposited into the debit account of the sender.

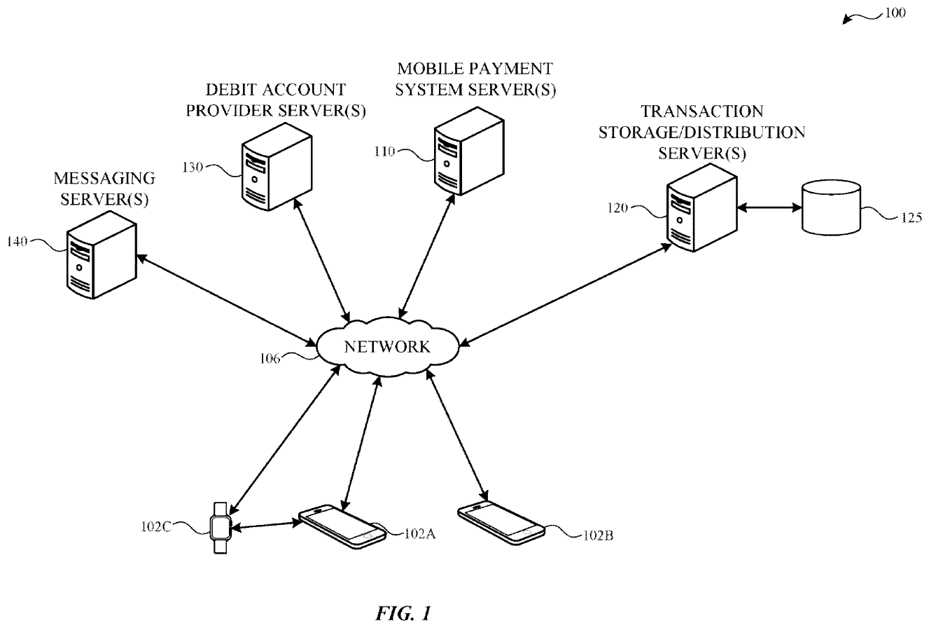

FIG. 1 illustrates an example network environment 100 in which a peer payment system may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes one or more electronic devices 102A-C, a network 106, one or more mobile payment system servers 110, one or more transaction storage/distribution servers 120, a transaction data store 125, one or more debit account provider servers 130, and one or more messaging servers 140. The network 106 may communicatively couple, for example, one or more of the electronic devices 102A-C to one or more of the servers 110, 120, 130, 140, and may communicatively couple any two or more of the servers 110, 120, 130, 140. In one or more implementations, the network 106 may be an interconnected network of devices that may include, or may be communicatively coupled to, the Internet.

The one or more mobile payment system servers 110 may include one or more servers that facilitate providing a mobile payment system to the electronic devices 102A-C. The one or more mobile payment system servers 110 may include one or more trusted services manager (TSM) servers, one or more broker servers, one or more application servers, and/or generally any servers that may facilitate providing a mobile payment system. In one or more implementations, an authorized user of the electronic devices 102A,C may have a user account with the mobile payment system provided by the one or more mobile payment system servers 110 and an authorized user of the electronic device 102B may have a separate user account with the mobile payment system. The user accounts may be used to manage the various card accounts and/or credentials that the users have registered with the mobile payment system, e.g., via the one or more mobile payment system servers 110.

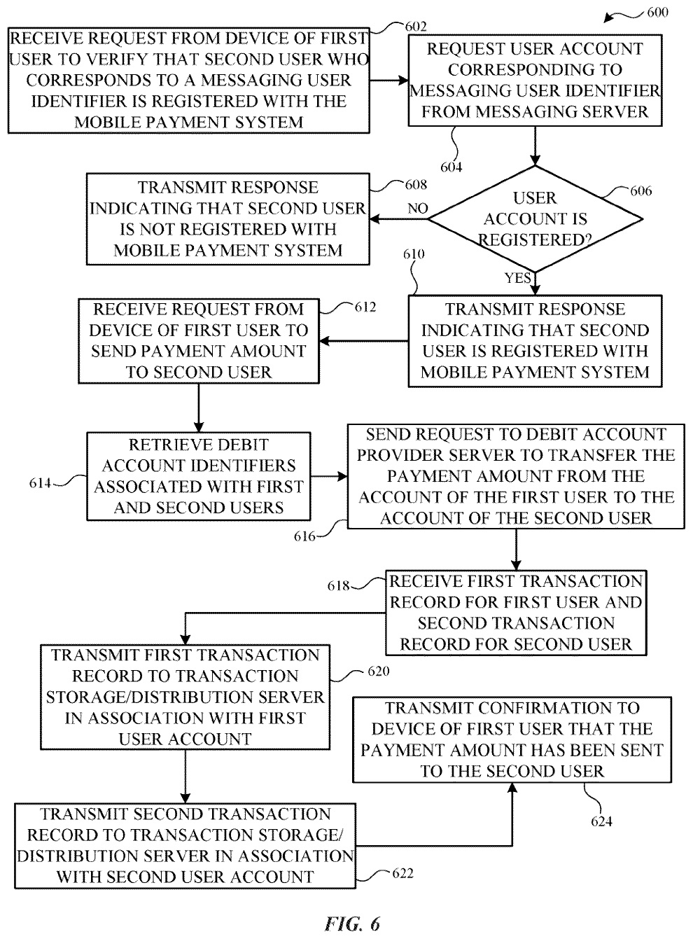

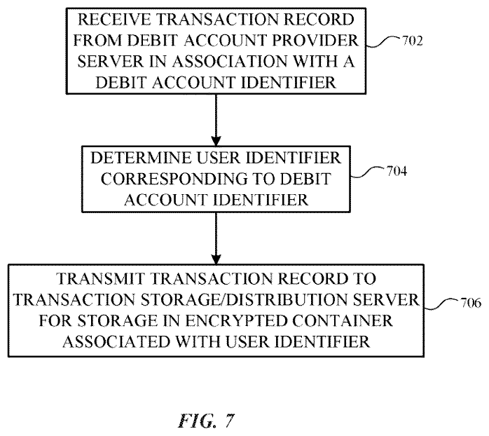

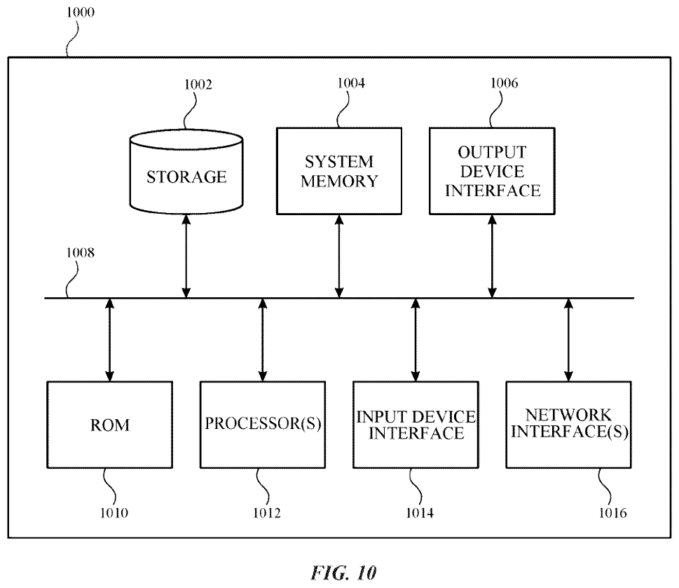

The one or more mobile payment system servers 110 may be, and/or may include all or part of, the electronic system discussed below with respect to FIG. 10, and example processes of the one or more mobile payment system servers 110 are discussed further below with respect to FIGS. 6 and 7. For explanatory purposes, the one or more mobile payment system servers 110 are generally described herein with reference to a single mobile payment system server 110. However, the one or more mobile payment system servers 110 may include multiple servers that may correspond to multiple different mobile payment systems.

The one or more transaction storage/distribution servers 120 may include one or more servers that may facilitate encrypting, storing, and distributing transaction records for the transactions conducted (e.g., by users) in the peer payment system. The one or more transaction storage/distribution servers 120 may be communicatively coupled to a transaction data store 125 in which the one or more transaction storage/distribution servers 120 may store transaction records (e.g., associated with the user accounts) of the peer payment system, such as transaction records received from the one or more mobile payment system servers 110. In order to ensure the privacy of the users, the transaction records associated with each user account are encrypted such that the transaction records can only be decrypted by the electronic devices associated with the corresponding user account.

For example, the transaction records associated with the authorized user account of the electronic devices 102A,C may be encrypted using a public key associated with the user account, where the private key is stored on one or more of the electronic devices 102A,C. In one or more implementations, instead of, or in addition to, storing the private key on the one or more of the electronic devices 102A,C, the private key may be derivable from information stored on the one or more of the electronic devices 102A,C and/or the private key may be derivable using data associated with and/or received from a user signed into the one or more of the electronic devices 102A,C. Alternatively, or in addition, the transaction records associated with the user account may be encrypted using a symmetric key that is specific to the user account, and that is stored on one or more of the electronic devices 102A,C.

The one or more transaction storage/distribution servers 120 may also facilitate synchronizing transaction records associated with a user account across all of the electronic devices corresponding to that user account. For example, when a new transaction record is stored in the transaction data store 125 for the authorized user of the electronic devices 102A,C, the one or more transaction storage/distribution servers 120 can notify each of the electronic devices 102A,C that the new transaction record is available. The electronic devices 102A,C may then retrieve the new transaction record from the one or more transaction storage/distribution servers 120.

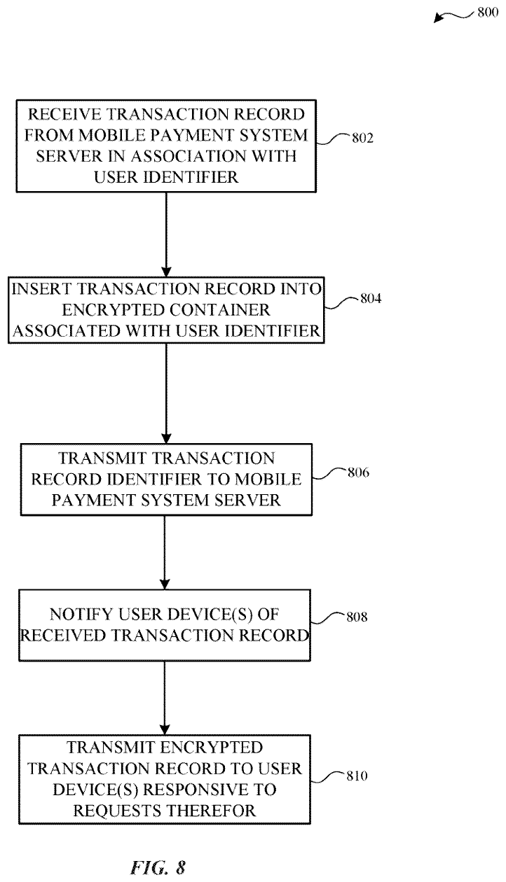

The one or more transaction storage/distribution servers 120 may be, and/or may include all or part of, the electronic system discussed below with respect to FIG. 10, and an example process of the one or more transaction storage/distribution servers 120 is discussed further below with respect to FIG. 8. For explanatory purposes, the one or more transaction storage/distribution servers 120 are generally described herein with reference to a single transaction storage/distribution server 120. However, the one or more transaction storage/distribution servers 120 may include any number of servers.

The one or more debit account provider servers 130 may include one or more servers that facilitate maintaining the debit accounts associated with the users (or user accounts) of the peer payment system. The one or more debit account provider servers 130 can be associated with one debit account provider or with multiple debit account providers. In one or more implementations, the one or more debit account provider servers 130 may not have access to any information regarding the users of the peer payment system or may have access to limited information regarding the users of the peer payment system. Thus, the one or more debit account provider servers 130 may receive payment commands from the one or more mobile payment system servers 110 that reference debit account identifiers, such as debit account numbers, and the one or more debit account provider servers 130 may transfer funds between the identified debit accounts accordingly. The one or more mobile payment system servers 110 may store a mapping from the identifiers of the user accounts of the peer payment system and the debit account identifiers corresponding to the users' debit accounts. The one or more debit account provider servers 130 may generate one or more transaction records after completing a payment, such as a transaction record for the sender and a transaction record for the recipient, and the one or more debit account provider servers 130 may provide the transaction records to the one or more mobile payment system servers 110. The one or more mobile payment system servers 110 may then provide the transaction records to the one or more transaction storage/distribution servers 120 for encryption and storage in the transaction data store 125.

The one or more debit account provider servers 130 may be, and/or may include all or part of, the electronic system discussed below with respect to FIG. 10. For explanatory purposes, the one or more debit account provider servers 130 are generally described herein with reference to a single debit account provider server 130. However, the one or more debit account provider servers 130 may include any number of servers.

The one or more messaging servers 140 may include one or more servers that facilitate providing a messaging service to users, such as the users of the peer payment system. The one or more messaging servers 140 may be, and/or may include all or part of, the electronic system discussed below with respect to FIG. 10. For explanatory purposes, the one or more messaging servers 140 are generally described herein with reference to a single messaging server 140. However, the one or more messaging servers 140 may include any number of servers.

One or more of the electronic devices 102A-C may be, for example, a portable computing device such as a laptop computer, a smartphone, a tablet device, a wearable device (e.g., watch, band, etc.), or other appropriate devices that include one or more wireless interfaces, such as one or more NFC radios, WLAN radios, Bluetooth radios, Zigbee radios, cellular radios, and/or other wireless radios. In FIG. 1, by way of example, the electronic devices 102A-B are depicted as mobile devices and the electronic device 102C is depicted as a smartwatch. In FIG. 1, the electronic devices 102A,C are illustrated as being paired to one another and are associated with the same user account, while the electronic device 102B is associated with a different user account. In one or more implementations, the user accounts may be provided by, and/or accessible to, the one or more mobile payment system servers 110.

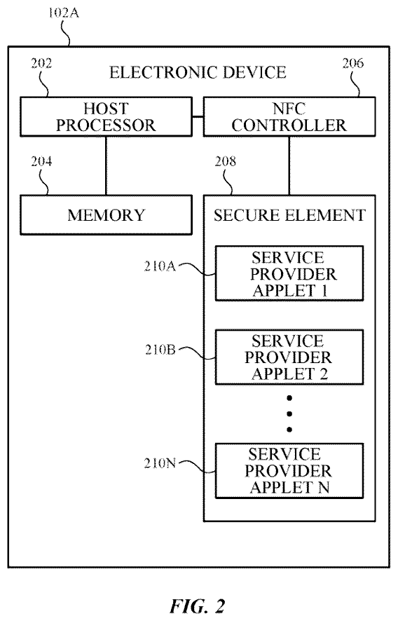

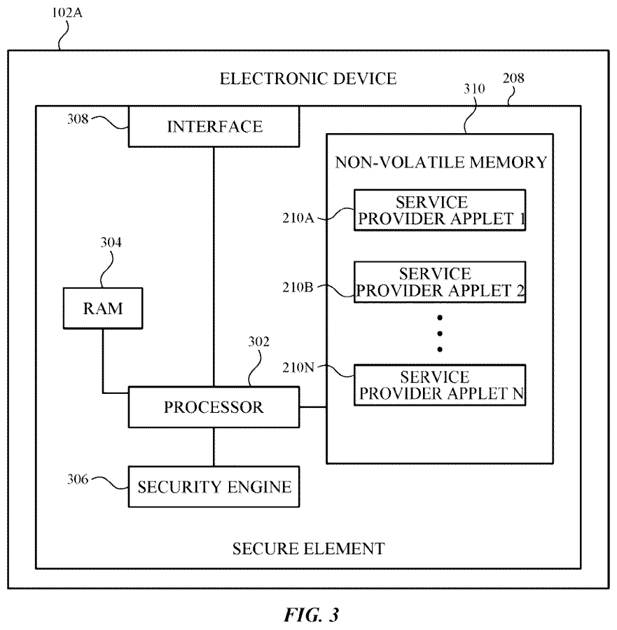

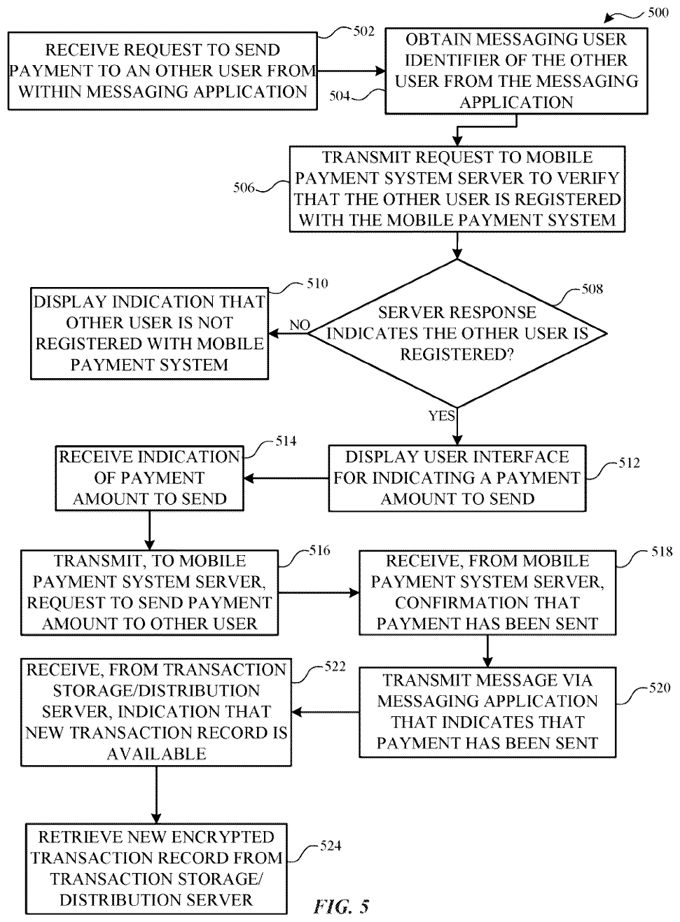

In one or more implementations, the electronic devices 102A-C may each include a secure element onto which one or more applets corresponding to, for example, credit/debit card accounts of the associated users, may be provisioned. An example electronic device that includes a secure element is discussed further below with respect to FIG. 2, and an example secure element is discussed further below with respect to FIG. 3. One or more of the electronic devices 102A-C may be, and/or may include all or part of, the electronic system discussed below with respect to FIG. 10. An example process of any of the electronic devices 102A-C in the subject peer payment system is discussed further below with respect to FIG. 5.

In the subject peer payment system, users of the mobile payment system provided by the one or more mobile payment system servers 110 may be registered for the peer payment system, such as automatically and/or upon agreeing to terms of service. In one or more implementations, users may need to have certain security mechanisms active on their account in order to participate in the peer payment system, such as two-factor authentication. When a user is registered for the peer payment system, the mobile payment system server 110 requests that a debit account be created for the user by the debit account provider server 130. After creating a debit account, the debit account provider server 130 may provide a debit account identifier for the debit account to the mobile payment system server 110. The mobile payment system server 110 may store a mapping between a user identifier (e.g., user account) associated with the user and the debit account identifier, such that information regarding the user is not provided to the debit account provider server 130.

When a user's debit account is created for the peer payment system, the mobile payment system server 110 may also facilitate creating an encrypted container for the user's transaction records at the transaction storage/distribution server 120. For example, the mobile payment system server 110 and/or the transaction storage/distribution server 120 may facilitate the electronic devices 102A,C of the user with generating one or more keys for encrypting and/or decrypting the transaction records stored in the container. The keys may be asymmetric keys or symmetric keys. The mobile payment system server 110 may facilitate transmission of the one or more keys to the electronic devices 102A,C of the user and/or to the transaction storage/distribution server 120, such that the electronic devices 102A,C can decrypt the user's transaction records.

The mobile payment system server 110 may also store a sentinel value in the container when the container is first created. The sentinel value may be returned to the mobile payment system server 110 when the mobile payment system server 110 sends additional transaction records for storage at the transaction storage/distribution server 120. However, if one or more of a user's keys are lost or damaged, the transaction storage/distribution server 120 may be unable to properly insert additional transaction records into the user's container, and therefore the incorrect sentinel value will be returned to the mobile payment system server 110, signaling to the mobile payment system server 110 that one or more of the keys have been lost or damaged. Responsive to determining that one or more of the keys have been lost or damaged, the mobile payment system server 110 may perform a recovery process to generate a new encrypted container for the user, retrieve all of the user's transaction records from the debit account provider server 130 and store the transaction records in the new encrypted container.

When the debit account is created for the user, an applet corresponding to the newly created debit account may be provisioned onto the secure element of one or more the electronic devices 102A,C of the user, such as the electronic device 102A. For example, a TSM server and/or a broker server, such as of the mobile payment system server 110 and/or the debit account provider server 130, may cause the applet corresponding to the debit account to be provisioned onto the secure element of the electronic device 102A, such as by transmitting a provisioning script to be executed by the secure element. The secure element may execute the provisioning script and provision the applet corresponding to the user's debit account for the peer payment system onto the secure element of the electronic device 102A.

In this manner, the user can use the debit account for wireless payment transactions with wireless payment terminals, in addition to using the debit account for peer payment transactions. When the user uses the electronic device 102A to conduct a wireless payment transaction with a wireless payment terminal, the electronic device 102A may pre-populate a transaction record for the payment transaction to be stored by the transaction storage/distribution server 120. For example, the electronic device 102A may pre-populate the transaction record with location information and/or other information that may not be available to the debit account provider server 130.

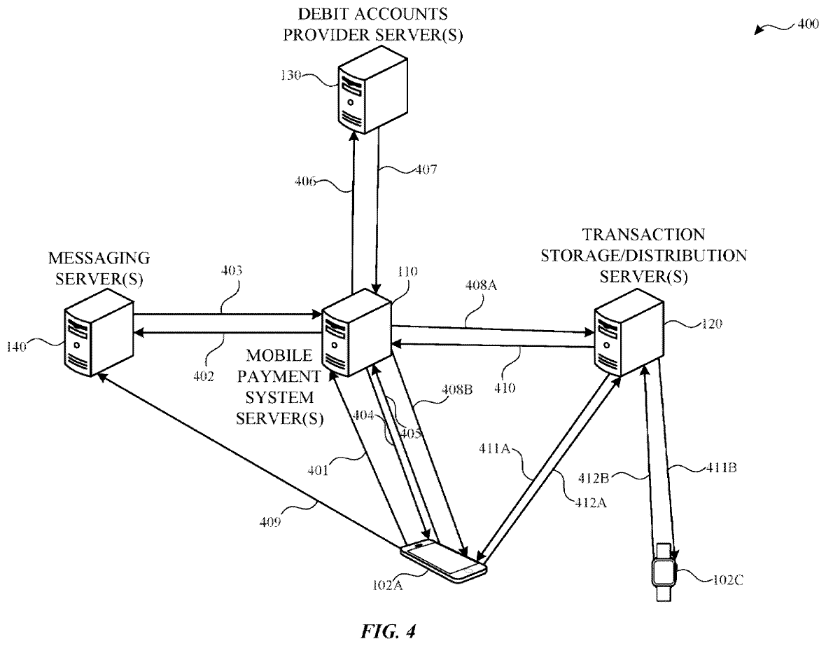

Once the mobile payment system server 110 has registered the user for the peer payment system, the user may begin using the peer payment system to send payments to other users. An example communication flow for sending a payment to another user is discussed further below with respect to FIG. 4.

FIG. 2 illustrates an example electronic device 102A that may be used in a peer payment system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. In one or more implementations, one or more components of the electronic device 102A may be implemented by one or more of the electronic devices 102B-C.

The electronic device 102A may include a host processor 202, a memory 204, an NFC controller 206, and a secure element 208. The secure element 208 may include one or more interfaces for communicatively coupling (directly or indirectly) to the NFC controller 206 and/or the host processor 202, such as via one or more single wire protocol (SWP) connections and/or any other data connection. The secure element 208 may include one or more provisioned service provider applets 210A-N, which may be referred to herein as applets 212A-N that may correspond to different service providers, such as credit card providers, debit card providers, transit providers, food/beverage providers, and the like. In one or more implementations, the operating system and/or execution environment of the secure element 208 may be a JAVA-based operating system and/or JAVA-based execution environment, and the applets 210A-N may be JAVA-based applets. In other implementations, other operating systems, languages, and/or environments can be implemented. In addition to the one or more applets 210A-N, the secure element 208 may also include one or more additional applets for performing other operations, such as a security applet, a registry applet, and the like.

The applets 210A-N may be provisioned on the secure element 208 in part by, for example, a trusted services manager server and/or a broker server, such as of the mobile payment system server 110 and/or the debit account provider server 130. For example, the trusted services manager server and/or the broker server may transmit a provisioning script to the electronic device 102A via the network 106. In some implementations, the host processor 202 of the electronic device 102A may receive the script and may provide the script to the secure element 208, such as via the NFC controller 206 and/or directly to the secure element 208. The secure element 208 may perform one or more security mechanisms to verify the received script, such as one or more security mechanisms inherent in the GlobalPlatform framework, and may then execute the received script.

The execution of the script by the secure element 208 may cause one or more of the applets 210A-N to be provisioned on the secure element 208, such as an applet corresponding to a debit account created for the peer payment system. Each of the applets 210A-N may be provisioned with one or more of: an applet identifier, a device primary account number (DPAN), an identifier of the associated service provider, and/or one or more attributes. The applet identifier associated with a given applet 210A may be used by, for example, the host processor 202 and/or the trusted services manager server to uniquely identify the applet 210A relative to the other applets 210A-N provisioned on the secure element 208, such as to perform one or more operations with respect to the applet 210A. In one or more implementations, the applet identifiers may be used by the host processor 202 to store associations between the applets 210A-N and the corresponding service providers.

The DPAN may be associated with a card account, such as a credit card account, that is associated with a given applet 210A. In contrast to the DPAN, the actual number that is printed on the physical card may be referred to as a funding primary account number (FPAN). When conducting a wireless payment transaction using one of the applets 210A-N, the secure element 208 may provide the DPAN to a wireless transaction terminal (e.g., without providing the FPAN which may not be stored on the secure element 208). The wireless transaction terminal may then forward the DPAN to the associated service provider who can determine the account (e.g., the FPAN) associated with the DPAN, and confirm that the account contains sufficient funds and/or credit to complete the wireless payment transaction. In one or more implementations, the DPAN may be associated with a card account that is associated with a given applet 210A, but there may not be a physical card corresponding to the DPAN.

In one or more implementations, the applets 210A-N may also be provisioned with an attribute that indicates the type of communication protocol used by the applets 210A-N to communicate with a wireless transaction terminal. The types of communication protocols may include, for example, an NFC-A protocol, an NFC-B protocol, an NFC-F protocol, a Bluetooth protocol, a Bluetooth low energy (BLE) protocol, a Zigbee protocol, a Wi-Fi protocol, or generally any communication protocol.

The NFC controller 206 may include one or more antennas and one or more transceivers for transmitting/receiving NFC communications. The NFC controller 206 may further include one or more interfaces, such as a single wire protocol interface, for coupling to the host processor 202 and/or the secure element 208. The NFC controller 206 may be able to communicate via one or more different NFC communication protocols, such as NFC-A (or Type A), NFC-B (or Type B), NFC-F (or Type F or FeliCA), and/or International Organization for Standardization (ISO)/International Electrotechnical Commission (IEC) 15693. The NFC-A protocol may be based on ISO/IEC 14443A and may use Miller bit coding with a 100 percent amplitude modulation. The NFC-B protocol may be based on ISO/IEC 14443B and may use variations of Manchester encoding along with a 10 percent modulation. The NFC-F protocol may be based on FeliCA JIS X6319-4 and may use a slightly different variation of Manchester coding than the NFC-B protocol.

For explanatory purposes, the electronic device 102A is illustrated in FIG. 2 as utilizing the NFC controller 206 to communicate with a wireless transaction terminal. However, the electronic device 102A may use any wireless communication controller and/or protocol to communicate with a wireless transaction terminal, such as Bluetooth, Bluetooth low energy, Wi-Fi, Zigbee, millimeter wave (mmWave), or generally any wireless communication controller and/or protocol.

The host processor 202 may include suitable logic, circuitry, and/or code that enable processing data and/or controlling operations of the electronic device 102A. In this regard, the host processor 202 may be enabled to provide control signals to various other components of the electronic device 102A. The host processor 202 may also control transfers of data between various portions of the electronic device 102A. Additionally, the host processor 202 may enable implementation of an operating system or otherwise execute code to manage operations of the electronic device 102A. The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

In one or more implementations, one or more of the host processor 202, the memory 204, the NFC controller 206, the secure element 208, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 3 illustrates an example electronic device 102A including an example secure element 208 that may be used in a peer payment system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The secure element 208 includes a secure processor 302, RAM 304, a security engine 306, an interface 308, and non-volatile memory 310. The RAM 304 may include one or more of static RAM (SRAM), and/or dynamic RAM (DRAM). The interface 308 may communicatively couple the security element 208 to one or more other chips in the device, such as the NFC controller 206 and/or the host processor 202. The interface 308 may be, for example, a SWP interface, a universal serial bus (USB) interface, or generally any data interface. The secure processor 302 may be, for example, a reduced instruction set computing (RISC) processor, an advanced RISC machine (ARM) processor, or generally any processing circuitry.

The security engine 306 may perform one or more security operations for the secure element 208. For example, the security engine 306 may perform cryptographic operations and/or may manage cryptographic keys and/or certificates. For example, the security engine 306 may manage one or more keys for accessing the user's encrypted transaction records. Furthermore the security engine 306 may manage a key or other security information that may be used by the electronic device 102A in the peer payment system to sign messages transmitted to the mobile payment system server 110 and/or the debit account provider server 130. In this manner, the user may not need to authenticate each time a payment is sent via the peer payment system, as the signing of messages by the security engine 306 and/or other components of the secure element 208 may be sufficient to effectively authenticate the user.

The non-volatile memory 310 may be and/or may include, for example, flash memory. The non-volatile memory 310 may store the attributes and executable code associated with the applets 210A-N. In one or more implementations, the non-volatile memory 310 may also store firmware and/or operating system executable code that is executed by the secure processor 302 to provide the execution environment for the applets 210A-N, such as a JAVA execution environment.

In one or more implementations, one or more of the secure processor 302, the RAM 304, the security engine 306, the interface 308, the non-volatile memory 310, and/or one or more portions thereof, may be implemented in software (e.g., subroutines and code), may be implemented in hardware (e.g., an ASIC, an FPGA, a PLD, a controller, a state machine, gated logic, discrete hardware components, or any other suitable devices) and/or a combination of both.

FIG. 4 illustrates an example communication flow 400 in a peer payment system in accordance with one or more implementations. For explanatory purposes, the steps of the communication flow 400 are described herein as occurring in serial, or linearly. However, multiple steps of the communication flow 400 may occur in parallel. In addition, multiple steps of the communication flow 400 need not be performed in the order shown and/or one or more steps of the communication flow 400 need not be performed and/or can be replaced by other operations.

The communication flow 400 includes the electronic devices 102A, C, the mobile payment system server 110, the transaction storage/distribution server 120, the debit account provider server 130, and the messaging server 140. The communication flow 400 begins when a user of the electronic device 102A requests, for example within a messaging application, to send a payment to another user (or user account). In one or more implementations, the user may be messaging with the other user via the messaging application. Responsive to the user's request, the electronic device 102A transmits a messaging user identifier associated with the other user to the mobile payment system server 110 (401). In one or more implementations, the electronic device 102A may also transmit the amount being requested along with device metadata to the mobile payment system server 110, e.g. data describing the electronic device 102A. The mobile payment system server 110 transmits a request to the messaging server 140 for the user identifier and/or account identifier associated with the messaging user identifier (402). The messaging server 140 responds to the request by transmitting the user identifier and/or user account associated with the messaging user identifier to the mobile payment system server 110 (403).

The mobile payment system server 110 determines, based on the user identifier, that the other user is registered to receive payments via the peer payment system, and the mobile payment system server 110 transmits an indication of the same to the electronic device 102A (404). In one or more implementations, the mobile payment system server 110 may also confirm that the device metadata is consistent with metadata expected for the electronic device 102A, and that the number of payment requests that the user of the electronic device 102A has made over a prior period of time does not exceed a payment request threshold. Upon confirming that the device metadata is consistent and that the number of payment requests does not exceed a payment request threshold, the mobile payment system server 110 may also transmit a formal request token to the electronic device 102A. In one or more implementations, the formal request token may be, for example, an opaque token or any other token.

The electronic device 102A receives the indication and/or the formal request token and provides the user with a user interface for indicating a payment amount to send to the other user. The user inputs a payment amount and the electronic device 102A transmits a request to the mobile payment system server 110 to send the payment amount from the user account (associated with electronic devices 102A, C) to the other user account (405). If the electronic device 102A received the formal request token from the mobile payment system server 110, the electronic device 102A may include the formal request token in the request transmitted to the mobile payment system server 110 to send the payment amount (405).

The mobile payment system server 110 receives the request and retrieves the debit account identifiers (e.g., numbers) corresponding to the debit accounts associated with the user accounts involved in the transaction. If the request includes the formal request token, the mobile payment system server 110 may verify that the formal request token is valid for the user of the electronic device 102A, e.g., whether the formal request token was issued to the user of the electronic device 102A, that the formal request token has not expired, and/or that the user of the electronic device 102A has not requested excessive formal request tokens since the formal request token was issued. If the verification of one or more of these factors fails, the mobile payment system server 110 may return an error to the electronic device 102A without processing the requested payment, and the electronic device 102A may present a message to the user indicating, for example, that the other user cannot currently receive payments. In this manner, the formal request token allows for implicit rate limiting of sending payment requests since only a certain number of the requests will be effective in invoking a payment response.

If the mobile payment system server 110 validates the conditions when the request includes the formal request token, the mobile payment system server 110 transmits, to the debit account provider server 130, a request to transfer the payment amount from the debit account number corresponding to electronic devices 102A,C (the payor) to the debit account number corresponding to the recipient (406). The debit account provider server 130 performs the transfer and generates two transaction records for the transfer, a first transaction record for the withdrawal of the payment amount from the debit account corresponding to electronic devices 102A,C and a second transaction record for the deposit of the payment amount into the debit account corresponding to the recipient (e.g., electronic device 102B). The debit account provider server 130 transmits the transaction records to the mobile payment system server 110 (407).

The mobile payment system server 110 receives the transaction records and transmits the transaction records, in conjunction with the associated user identifiers, to the transaction storage/distribution server 120 for storage in the users' respective encrypted containers (408A), and the mobile payment system server 110 transmits a confirmation of the payment to the electronic device 102A (408B). The transaction storage/distribution server 120 encrypts the transaction records using the respective users' encryption keys and stores the encrypted transaction records in the respective users' containers (e.g., the containers associated with the respective user accounts). The transaction storage/distribution server 120 then notifies the electronic devices 102A,C that a new transaction record is available (411A-B). The electronic devices 102A,C each can individually retrieve the new transaction record from the transaction storage/distribution server 120 (412A-B), and decrypt the transaction record, such as using a decryption key stored in the respective secure elements of the electronic devices 102A,C. The transaction storage/distribution server 120 also transmits transaction record identifiers for the transaction records to the mobile payment system server 110 (410), such that the mobile payment system server 110 can subsequently reference the transaction records.

The electronic device 102A receives the confirmation from the mobile payment system server 110 that the payment was successfully sent to the other user, and the electronic device 102A can transmit a message to the other user via the messaging server 140 indicating the same (409). In one or more implementations, the message may be sent with additional content (e.g., any/all of text, an image, a media file, etc.) regarding the payment that was provided, such as a reason for the payment. The additional content may be tagged such that the electronic device 102A (and the electronic device of the other user) can extract the additional content from the message and store the additional content in the users' individual transaction records for the payment. Further, the message in the messaging application that indicates a payment is being provided can be presented in the context of a message thread (or conversation). For example, a message thread regarding a shared meal can also include a payment message for one person's portion of the cost. The message indicating the payment can remain part of the message thread, so that the peer payment transaction also can be located through examination of the thread. In some embodiments, the message indicating the payment can be presented using a graphical differentiation, such as a different size, color, font, texture, etc. Further, in some embodiments, the message indicating the payment can change relative position in the thread based upon an action, status, etc.

In one or more implementations, the other user may be partially registered with the peer payment system, but may not have completed the registration. For example, the other user may not have accepted the terms of service. In such an instance, a message may be transmitted (e.g., from the electronic device 102A) to the electronic device of the other user via the messaging server 140 that indicates that the other user needs to complete the registration so that they can receive the payment. The message may include a link or other selectable element that the other user may select to complete the registration with the mobile payment system server 110. Once the other user completes the registration, the payment may be automatically completed by the mobile payment system server 110 and the debit account provider server 130.

FIG. 5 illustrates a flow diagram of an example process 500 of an electronic device 102A sending a payment in accordance with one or more implementations. For explanatory purposes, the process 500 is primarily described herein with reference to the electronic device 102A of FIGS. 1-4. However, the process 500 is not limited to the electronic device 102A of FIGS. 1-4, and one or more blocks (or operations) of the process 500 may be performed by one or more other components or chips of the electronic device 102A. The electronic device 102A also is presented as an exemplary device and the operations described herein may be performed by any suitable device, such as one or more of the electronic devices 102B-C. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

The process 500 is initiated when the electronic device 102A receives a request from a user, for example within a messaging application, to send a payment to another user, such as another user associated with the electronic device 102B (502). For example, the electronic device 102A may provide a peer payment system application within the messaging application, and the request may be received when the user opens the peer payment system application within the messaging application. The electronic device 102A, such as via the peer payment system application, obtains the messaging user identifier of the other user from the messaging application (504). The messaging user identifier of the other user may be an identifier that is used by the other user in the messaging application, and/or may be a phone number or other identifier of the other user.

The electronic device 102A transmits a request to the mobile payment system server 110 to verify that the other user is registered with the mobile payment system and can receive peer payments (506). A response is subsequently received from the mobile payment system server 110. If the response from the mobile payment system server 110 indicates that the other user is not registered and/or is not able to receive peer payments (508), the electronic device 102A displays an indication that the other user is not registered with the mobile payment system and/or is otherwise unable to receive peer payments (510). In some embodiments, the other user may optionally receive an invite to register with the mobile payment system, e.g., in order to receive peer payments. If the response from the mobile payment system server 110 indicates that the other user is registered with the mobile payment system and is able to receive peer payments (508), the electronic device 102A displays a user interface that allows the user to indicate a payment amount to send to the other user (512).

The user may input a payment amount, such as using the user interface, and the electronic device 102A may receive, via the user interface, an indication of the payment amount to send to the other user (514). The electronic device 102A transmits, to the mobile payment system server 110, a request to transfer the payment amount from the debit account associated with the requesting user (payor) to the debit account of the receiving user (516). When the payment amount is successfully transferred (or sent) to the receiving user, the electronic device 102A receives, from the mobile payment system server 110, a confirmation that the payment has been sent (518). The electronic device 102A then transmits a message to the receiving user via the messaging application, indicating that the payment has been sent (520). A memo, note, or other content (e.g., text, audio, media, etc.) may be transmitted in conjunction with the payment message and can be extracted and added to the respective transaction records associated with the payment.

The electronic device 102A receives, from the transaction storage/distribution server 120, an indication that a new transaction record is available (522). The electronic device 102A retrieves the new encrypted transaction record from the transaction storage/distribution server 120 (524). The electronic device 102A may decrypt the transaction record and may provide the transaction record for display. For example, an application on the electronic device 102A that is associated with the mobile payment system, such as a wallet application, may display the decrypted transaction records to the user.

FIG. 6 illustrates a flow diagram of an example process 600 of a mobile payment system server 110 facilitating a peer payment in accordance with one or more implementations. For explanatory purposes, the process 600 is primarily described herein with reference to the mobile payment system server 110 of FIGS. 1 and 4. However, the process 600 is not limited to the mobile payment system server 110 of FIGS. 1 and 4, and one or more blocks (or operations) of the process 600 may be performed by one or more other components or chips of the mobile payment system server 110. The mobile payment system server 110 also is presented as an exemplary device and the operations described herein may be performed by any suitable device, such as one or more of the other servers 120, 130, 140. Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

The process 600 is initiated when the mobile payment system server 110 receives a request from an electronic device 102A associated with a first user to verify that a second user (or user account) who corresponds to a messaging user identifier is registered with the mobile payment system and can receive peer payments (602). In one or more implementations, the second user may be associated with another electronic device, such as electronic device 102B. The mobile payment system server 110 may request, from the messaging server 140, a user identifier or user account corresponding to the messaging user identifier (604). The mobile payment system server 110 receives a response from the messaging server 140 that includes the corresponding user identifier and/or an indication of the corresponding user account.

If the user account is not registered with the mobile payment system and/or the peer payment system (606), the mobile payment system server 110 transmits a response to the electronic device 102A that indicates that the second user is not registered with the mobile payment system server 110 and/or is not registered to receive peer payments (608). If the user account is registered with the mobile payment system server 110 and is able to receive peer payments (606), the mobile payment system server 110 transmits a response to the electronic device 102A that indicates that the second user is registered with the mobile payment system and/or is able to receive peer payments (610).

The mobile payment system server 110 then receives a request from the electronic device 102A of the first user to send a payment amount to the second user (612). The mobile payment system server 110 retrieves the respective debit account identifiers associated with the first (payor) and second (recipient) users (614), and the mobile payment system server 110 transmits a request to the debit account provider server 130 to transfer the payment amount from the debit account of the first user to the debit account of the second user (616). After the debit account provider server 130 completes the payment, the mobile payment system server 110 receives, from the debit account provider server 130, a first transaction record for the first user and a second transaction record for the second user (618).

The mobile payment system server 110 transmits the first transaction record to the transaction storage/distribution server 120 in association with the first user account and/or the first user identifier (620), and the mobile payment system server 110 transmits the second transaction record to the transaction storage/distribution server 120 in association with the second user account and/or the second user identifier (622). The mobile payment system server 110 also transmits, to the electronic device 102A of the first user, a confirmation that the payment amount has been sent to the second user (624).

FIG. 7 illustrates a flow diagram of an example process 700 of a mobile payment system server 110 providing transaction records from a debit account provider server 130 to a transaction storage/distribution server 120 in accordance with one or more implementations. For explanatory purposes, the process 700 is primarily described herein with reference to the mobile payment system server 110 of FIGS. 1 and 4. However, the process 700 is not limited to the mobile payment system server 110 of FIGS. 1 and 4, and one or more blocks (or operations) of the process 700 may be performed by one or more other components or chips of the mobile payment system server 110. The mobile payment system server 110 also is presented as an exemplary device and the operations described herein may be performed by any suitable device, such as one or more of the other servers 120, 130, 140. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

The process 700 is initiated when the mobile payment system server 110 receives a transaction record from the debit account provider server 130 in association with a debit account identifier (702). For example, the debit account provider server 130 may not have access to identifiers of the users and may instead only reference debit account numbers. In one or more implementations, the mobile payment system server 110 may transmit user identifiers to the debit account provider server 130 when sending a payment transaction to the debit account provider server 130, and the debit account provider server 130 may include the user identifiers when transmitting the transaction records to the mobile payment system server 110.

The mobile payment system server 110 determines the user identifier corresponding to the debit account identifier that was transmitted with the transaction record (704). For example, the mobile payment system server 110 may retrieve the user identifier from a table that maps the user identifiers (e.g., an account identifier or phone number associated with the messaging application) to the debit account identifiers. The mobile payment system server 110 transmits the transaction record to the transaction storage/distribution server 120 for storage in an encrypted container associated with the user identifier (706).

For explanatory purposes, the transaction record is described in FIG. 7 as originating from the debit account provider server 130. However, the mobile payment system server 110 may receive transaction records from any service provider server that provides a service to the user, and the mobile payment system server 110 may transmit the transaction records to the transaction storage/distribution server 120 for storage in the encrypted container associated with the user identifier. For example, the mobile payment system server 110 may receive transaction records from one or more service providers that have provisioned one of the applets 210A-N on the secure element 208 of the electronic device 102A. The transaction records from the one or more service providers may correspond to payment transactions conducted using the applets 210A-N as well as payment transactions conducted using physical cards, such as physical credit cards.

FIG. 8 illustrates a flow diagram of an example process 800 of a transaction storage/distribution server 120 in accordance with one or more implementations. For explanatory purposes, the process 800 is primarily described herein with reference to the transaction storage/distribution server 120 of FIGS. 1 and 4. However, the process 800 is not limited to the transaction storage/distribution server 120 of FIGS. 1 and 4, and one or more blocks (or operations) of the process 800 may be performed by one or more other components or chips of the transaction storage/distribution server 120. The transaction storage/distribution server 120 also is presented as an exemplary device and the operations described herein may be performed by any suitable device, such as one or more of the other servers 110, 130, 140. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

The process 800 is initiated when the transaction storage/distribution server 120 receives a transaction record from the mobile payment system server 110 in association with a user identifier (802). The transaction storage/distribution server 120 inserts the transaction record into an encrypted container associated with the user identifier (804). In one or more implementations, the encrypted container may be stored in the transaction data store 125. For example, the encrypted container may be and/or may include a flat table, and the transaction storage/distribution server 120 may encrypt the received transaction record using a key associated with the user identifier and may store the encrypted transaction record as a row of the flat table. In one or more implementations, the transaction record may be provided to a process that both encrypts the transaction record and inserts the transaction record into a row of the table of the encrypted container.

When the transaction record is inserted into the encrypted container, a transaction record identifier is generated. The transaction storage/distribution server 120 transmits the transaction record identifier to the mobile payment system server 110 such that the mobile payment system server 110 can later replace all or part of the transaction record (806). The transaction storage/distribution server 120 notifies the electronic devices 102A,C associated with the user identifier that the transaction record has been added to the encrypted container (808). The transaction storage/distribution server 120 may then transmit the encrypted transaction record to the electronic devices 102A,C of the user in response to requests therefor (810). In one or more implementations, the transaction storage/distribution server 120 may transmit the delta between the current version of the encrypted container and the prior version of the encrypted container that was transmitted to each of the respective electronic devices 102A,C. In one or more implementations, the transaction storage/distribution server 120 may transmit the entirety of the encrypted container each time a transaction record is added to the encrypted container.

In one or more implementations, the transaction storage/distribution server 120 may utilize a transport mechanism of a cloud synchronization and/or storage system to notify the electronic devices 102A,C of the updates to the encrypted container.

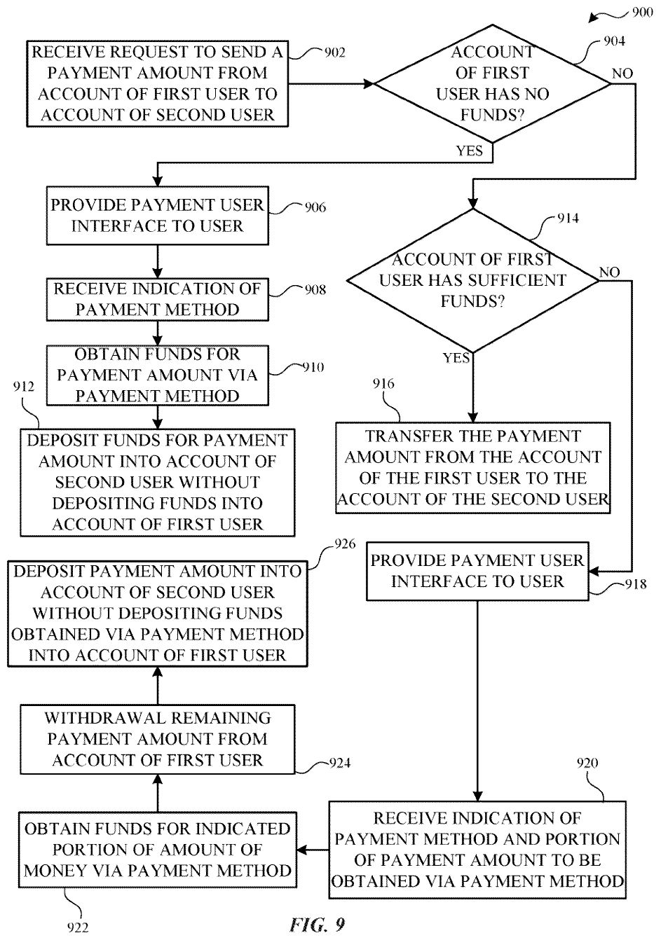

FIG. 9 illustrates a flow diagram of an example process 900 of funding a peer payment in accordance with one or more implementations. For explanatory purposes, the process 900 is primarily described herein with reference to the mobile payment system server 110 and the debit account provider server 130 of FIGS. 1 and 4. However, the process 900 is not limited to the mobile payment system server 110 and/or the debit account provider server 130 of FIGS. 1 and 4, and one or more blocks (or operations) of the process 900 may be performed by one or more other components or chips of the mobile payment system server 110 and/or the debit account provider server 130. The mobile payment system server 110 and the debit account provider server 130 also are presented as exemplary devices and the operations described herein may be performed by any suitable device, such as one or more of the other servers 120, 140. Further for explanatory purposes, the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

The process 900 is initiated when the debit account provider server 130 receives a request from the mobile payment system server 110 to send a payment amount from an account of a first user (payor) to an account of a second user (recipient) (902). In some implementations, the debit account provider can maintain both the payor and recipient accounts, while in other implementations different debit account providers can maintain the payor and recipient accounts. The users may be identified in the request by debit account identifiers rather than user identifiers.

If the debit account provider server 130 determines that the account of the first user does not have any funds to send the payment amount (904), the debit account provider server 130 notifies the mobile payment system server 110 of the same, and the mobile payment system server 110 provides a payment user interface for display to the user, such as on the electronic device 102A (906). The payment user interface may allow the user to select an external source of funding, such as a bank account or a credit card, to fund the payment. In some embodiments, the payment user interface may be linked to or otherwise associated with an electronic wallet application that includes one or more payment credentials that can be selected to fund the payment. The user may interact with the user interface to provide a payment method for funding the payment and the mobile payment system server 110 may receive an indication of the same, such as from the electronic device 102A (908).

The mobile payment system server 110 and/or the debit account provider server 130, obtain the funds for the payment amount via the payment method (910), and the funds for the payment amount are deposited directly into the account of the second user without being deposited into the account of the first user (912). In this manner, the funds are not routed through the account of the first user. In some other embodiments, the funds for the payment amount can be deposited into the account associated with the first user (payor), e.g., by topping up their account, before being transferred to the account associated with the second user (recipient).

If the debit account provider server 130 determines that the account of the first user has funds to send the payment (904), and the funds are sufficient to cover the entire payment amount (914), e.g., the balance of the account of the first user is greater than or equal to the entire payment amount, the debit account provider server 130 transfers the payment amount from the account of the first user to the account of the second user (916).

If the debit account provider server 130 determines that the account of the first user has funds to send the payment (904), but the funds are not sufficient to cover the entire payment amount (914), e.g., the balance of the account of the first user is greater than zero but less than the payment amount, the debit account provider server 130 notifies the mobile payment system server 110 of the same, and the mobile payment system server 110 provides a payment user interface for display to the user, such as on the electronic device 102A (918). The payment user interface may allow the user to select an external source of funding, such as a bank account, a debit card, or a credit card, to fund a portion (any or all) of the payment. The user may interact with the user interface to provide a payment method for funding the payment and to indicate how much of the payment amount should come from the debit account of the first user and how much of the payment amount should come from the other payment method, and the mobile payment system server 110 receives an indication of the same, such as from the electronic device 102A (920). In one or more implementations, the first user may also be able to indicate an amount of funds from the payment method that should be deposited into the first user's debit account after the payment amount has been sent. In one or more implementations, the user may interact with the user interface to provide multiple payment methods and to indicate how much of the payment amount should come from each of the payment methods.

The mobile payment system server 110 and/or the debit account provider server 130, obtain the funds for the indicated portion of the payment amount via the indicated payment method (922), and the debit account provider server 130 withdrawals the remaining amount from the debit account of the first user (924). The debit account provider server 130 then deposits the combined funds for the payment amount into the debit account of the second user without depositing the funds obtained via the payment method into the account of the first user (926).

As described above, one aspect of the present technology is the gathering and use of data available from various sources to provide a peer transaction system. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to identify content and/or an item for which a user may wish perform a peer transaction. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of a peer transaction system, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, suggested peers to perform a peer transaction with can be determined by inferring preferences based on non-personal information data or a bare minimum amount of personal information, such as content being requested by the device associated with a user, other non-personal information available to the peer transaction system, or publicly available information.

FIG. 10 conceptually illustrates an electronic system 1000 with which one or more implementations of the subject technology may be implemented. The electronic system 1000 can be, and/or can be a part of, one or more of the electronic devices 102A-C, and/or one or more of the servers 110, 120, 130, 140 shown in FIG. 1. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In one or more implementations, the processes of the subject disclosure are stored in the system memory 1004, the permanent storage device 1002, and/or the ROM 1010. From these various memory units, the one or more processing unit(s) 1012 retrieves instructions to execute and data to process in order to execute the processes of one or more implementations.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1-20. (canceled)

21. A device comprising:
a memory; and
at least one processor configured to:
receive, within an application on the device and in association with a first user account, a request to access a service in conjunction with a second user account;
obtain, via the application on the device, a second user account identifier corresponding to the second user account;
transmit, to a service provider server associated with the service, a request to verify that the second user account is registered with the service, the request comprising the second user account identifier;
receive, from the service provider server, a response that indicates whether the second user account is registered with the service, wherein the response includes a security token for performing the service in conjunction with the second user account when the second user account is registered with the service;
when the response received from the service provider server indicates that the second user account is registered with the service and the response includes the security token for performing the service in conjunction with the second user account:
display, within the application on the device, a user interface for receiving user input for performing the service in conjunction with the second user account;
receive, via the user interface, the user input for performing the service;
transmit, to the service provider server and via a first secure communication channel, a request to perform the service in conjunction with the second user account, the request comprising the user input and the security token provided by the service provider server for performing the service in conjunction with the second user account;
receive, from the service provider server via the first secure communication channel when the service provider server verifies the security token for performing the service in conjunction with the second user account, an indication that the service has been performed by the service provider server with respect to the first user account and the second user account;
transmit, to a second device associated with the second user account via a second secure communication channel, another indication that the service was performed by the service provider server with respect to the first user account and the second user account; and
display, via the application on the device, the indication that indicates that the service was performed by the service provider server with respect to the first user account and the second user account; and
when the response received from the service provider server indicates that the second user account is not registered with the service, display, within the application on the device, an indication that the second user account is not registered with the service while foregoing display, within the application on the device, of the user interface for receiving the user input for performing the service.

22. The device of claim 21, wherein the first secure communication channel is different than the second secure communication channel.

23. The device of claim 22, wherein the second secure communication channel bypasses the service provider server.

24. The device of claim 21, wherein the at least one processor is further configured to:
receive, from a storage server, a notification that a service access record is available;
retrieve, from the storage server, the service access record; and
display the service access record, wherein the service access record corresponds to the access of the service by the first user account in conjunction with the second user account.

25. The device of claim 24, wherein the storage server is separate from the service provider server.

26. The device of claim 24, wherein the service access record retrieved from the storage server is encrypted using a public key associated with the first user account, and the at least one processor is further configured to:
decrypt the service access record using a private key associated with the first user account.

27. The device of claim 26, further comprising a secure element configured to store the private key.

28. A non-transitory machine-readable medium comprising instructions that, when executed by one or more processors cause the one or more processors to perform operations comprising:
receiving, within an application on a device and in association with a first user account, a request to access a service in conjunction with a second user account;
obtaining, via the application on the device, a second user account identifier corresponding to the second user account;
transmitting, to a service provider server associated with the service, a request to verify that the second user account is registered with the service, the request comprising the second user account identifier;
receiving, from the service provider server, a response that indicates whether the second user account is registered with the service, wherein the response includes a security token for performing the service in conjunction with the second user account when the second user account is registered with the service;
when the response received from the service provider server indicates that the second user account is registered with the service and the response includes the security token for performing the service in conjunction with the second user account:
displaying, within the application on the device, a user interface for receiving user input for performing the service in conjunction with the second user account;
receiving, via the user interface, the user input for performing the service;
transmitting, to the service provider server and via a first secure communication channel, a request to perform the service in conjunction with the second user account, the request comprising the user input and the security token provided by the service provider server for performing the service in conjunction with the second user account;
receiving, from the service provider server via the first secure communication channel when the service provider server verifies the security token for performing the service in conjunction with the second user account, an indication that the service has been performed by the service provider server with respect to the first user account and the second user account;
transmitting, to a second device associated with the second user account via a second secure communication channel, another indication that the service was performed by the service provider server with respect to the first user account and the second user account; and
displaying, via the application on the device, the indication that indicates that the service was performed by the service provider server with respect to the first user account and the second user account; and
when the response received from the service provider server indicates that the second user account is not registered with the service, displaying, within the application on the device, an indication that the second user account is not registered with the service while foregoing display, within the application on the device, of the user interface for receiving the user input for performing the service.

29. The non-transitory machine-readable medium of claim 28, wherein the first secure communication channel is different than the second secure communication channel.

30. The non-transitory machine-readable medium of claim 29, wherein the second secure communication channel bypasses the service provider server.

31. The non-transitory machine-readable medium of claim 28, wherein the operations further comprise:
receiving, from a storage server, a notification that a service access record is available;
retrieving, from the storage server, the service access record; and
displaying the service access record, wherein the service access record corresponds to the access of the service by the first user account in conjunction with the second user account.

32. The non-transitory machine-readable medium of claim 31, wherein the storage server is separate from the service provider server.

33. The non-transitory machine-readable medium of claim 31, wherein the service access record retrieved from the storage server is encrypted using a public key associated with the first user account, and the operations further comprise:
decrypting the service access record using a private key associated with the first user account.

34. A method comprising:
receiving, within an application on a device and in association with a first user account, a request to access a service in conjunction with a second user account;
obtaining, via the application on the device, a second user account identifier corresponding to the second user account;
transmitting, to a service provider server associated with the service, a request to verify that the second user account is registered with the service, the request comprising the second user account identifier;
receiving, from the service provider server, a response that indicates whether the second user account is registered with the service, wherein the response includes a security token for performing the service in conjunction with the second user account when the second user account is registered with the service;
when the response received from the service provider server indicates that the second user account is registered with the service and the response includes the security token for performing the service in conjunction with the second user account:
displaying, within the application on the device, a user interface for receiving user input for performing the service in conjunction with the second user account;
receiving, via the user interface, the user input for performing the service;
transmitting, to the service provider server and via a first secure communication channel, a request to perform the service in conjunction with the second user account, the request comprising the user input and the security token provided by the service provider server for performing the service in conjunction with the second user account;
receiving, from the service provider server via the first secure communication channel when the service provider server verifies the security token for performing the service in conjunction with the second user account, an indication that the service has been performed by the service provider server with respect to the first user account and the second user account;
transmitting, to a second device associated with the second user account via a second secure communication channel, another indication that the service was performed by the service provider server with respect to the first user account and the second user account; and
displaying, via the application on the device, the indication that indicates that the service was performed by the service provider server with respect to the first user account and the second user account; and
when the response received from the service provider server indicates that the second user account is not registered with the service, displaying, within the application on the device, an indication that the second user account is not registered with the service while foregoing display, within the application on the device, of the user interface for receiving the user input for performing the service.

35. The method of claim 34, wherein the first secure communication channel is different than the second secure communication channel.

36. The method of claim 35, wherein the second secure communication channel bypasses the service provider server.

37. The method of claim 34, further comprising:
receiving, from a storage server, a notification that a service access record is available;
retrieving, from the storage server, the service access record; and
displaying the service access record, wherein the service access record corresponds to the access of the service by the first user account in conjunction with the second user account.

38. The method of claim 37, wherein the storage server is separate from the service provider server.

39. The method of claim 37, wherein the service access record retrieved from the storage server is encrypted using a public key associated with the first user account, and the method further comprises:
decrypting the service access record using a private key associated with the first user account.

40. The method of claim 39, wherein the device further comprises a secure element configured to store the private key.
